(19) United States
(12) Patent Application Publication
(10) Pub. No.: US 2006/0047832 A1
(43) Pub. Date: Mar. 2, 2006

(54) Method and apparatus for processing web service messages

(76) Inventors: Christopher Betts, Mt. Dandenong (AU); Tony Rogers, Rowville (AU)

Correspondence Address: BAKER BOTTS L.L.P., 2001 ROSS AVENUE, SUITE 600, DALLAS, TX, 75201-2980, US

(21) Appl. No.: 11/132,632

(22) Filed: May 19, 2005

Related U.S. Application Data
(60) Provisional application No. 60/573,552, filed on May 21, 2004.

(51) Int. Cl. G06F 15/16

(52) U.S. Cl. 709/229

(57) ABSTRACT

Methods and apparatuses for processing a web service message are provided. The apparatus includes a data store and firewall logic means. The data store stores configurable firewall criteria. An interface can optionally be provided for configuring the firewall criteria. A web service message is processed through the firewall logic means which applies the firewall criteria stored in the data store.

### CROSS-REFERENCE TO RELATED APPLICATION

This application claims the benefit of U.S. provisional application Ser. No. 60/573,552, filed May 21, 2004 and entitled “METHOD AND APPARATUS FOR PROCESSING WEB SERVICE MESSAGES”.

### TECHNICAL FIELD

The present disclosure relates generally to web services and, more particularly, to methods and apparatuses for processing web service messages.

### DESCRIPTION OF THE RELATED ART

Computer systems are commonly used by enterprises and other organizations to store and manage information (in many instances, confidential and/or sensitive information). Constituents of the enterprises and organizations often have around-the-clock access to the stored information through the use of websites and related web-based services. Computer systems as referred to herein may include individual computers, servers, computing resources, networks, etc.

Web services are automated resources that can be accessed over, for example, a wide area network (WAN) the Internet, etc. Web services typically are designed to perform a specific function and can be accessible to a wide group of prospective users which may include human users as well as other software systems. Web services generally are identified by Universal Resource Identifiers (URIs), analogous to identification of websites by Uniform Resource Locators (URLs). Web services typically communicate in human readable Extensible Markup Language (XML) and may use the Unicode text format to be accessible across numerous platforms and in various languages. In this way, web services enhance the way computers communicate with users and with each other.

The more web services are used for various applications, the more their functionality, performance, and overall quality promote their acceptance and widespread use. The human readable, text based nature of XML makes XML significantly more verbose, and sometimes more complex, than other data structures. This results in large data structures with an intricate internal structure, making the parsing of XML based web service messages an expensive computational operation. In addition, the monitoring of XML web service messages for events such as, invalid XML, invalid Unicode, canonicalization, attempts to access improper services, signature verification, etc. can also reduce the performance of an XML server.

Some XML firewall appliances perform XML processing within a dedicated single purpose device. However, in many instances the appliances lack hard drives or other computing accessories and are hard-coded (such as in chip-based firmware), rack mountable network boxes. They typically perform a specific operation, such as encryption/decryption, or are generic devices that run Extensible Stylesheet Language Transformation (XSLT) transforms over an XML data stream. XSLT is a transformational scripting language that can convert XML data to another format, including other types of XML.

However, there remains a need for a reliable and efficient way to validate and authorize web service messages.

### SUMMARY

This application describes methods and apparatuses for processing a web service message. According to one exemplary embodiment of the present disclosure, an apparatus for processing a web service message, includes a data store for storing configurable firewall criteria, and firewall logic means for processing a web service message according to the firewall criteria stored in the data store.

An apparatus for processing a web service message, according to another exemplary embodiment, includes a data repository for storing parameters to be used by a firewall, means for enabling a user to configure the parameters stored in the data repository, means for processing the web service message, means for determining whether data in the web service message is valid, means for determining whether a source of the web service message is authorized to pass through the firewall, and means for allowing the web service message to pass through the firewall if it is determined that the web service message is authorized to pass through the firewall.

A method for processing a web service message, according to an exemplary embodiment, includes providing a data store for storing configurable firewall criteria, providing a user with an interface for configuring the firewall criteria, and processing a web service message through firewall logic means which applies the firewall criteria stored in the data store.

According to another exemplary embodiment, a method for processing a web service message includes providing a data repository for storing parameters to be used by a firewall, enabling a user to configure the parameters stored in the data repository, providing means for processing the web service message, determining whether data in the web service message is valid, determining whether a source of the web service message is authorized to pass through the firewall, and allowing the web service message to pass through the firewall if it is determined that the web service message is authorized to pass through the firewall.

The methods and apparatuses of this disclosure may be embodied in one or more computer programs stored on a computer readable medium or program storage device and/or transmitted via a computer network or other transmission medium in one or more segments or packets.

### BRIEF DESCRIPTION OF THE DRAWINGS

The features of the present application can be more readily understood from the following detailed description with reference to the accompanying drawings wherein:

FIG. 1 shows a block diagram of an exemplary computer system capable of implementing the methods and apparatuses of the present disclosure;

FIG. 2A shows a block diagram illustrating an apparatus for processing a web service message, according to one exemplary embodiment of the present disclosure;

FIG. 2B shows a flow chart illustrating a method for processing a web service message, according to the embodiment of FIG. 2A;

FIG. 3 shows a block diagram illustrating an apparatus for processing a web service message, according to another exemplary embodiment; and

FIG. 4 shows a flow chart illustrating a method for processing a web service message, according to another embodiment.

### DETAILED DESCRIPTION

The present disclosure provides tools (in the form of methodologies, apparatuses, and systems) for processing a web service message. The tools allow a user to configure firewall criteria or parameters to be used by a firewall device to determine whether to pass through a web service message to a computer system.

The following exemplary embodiments are set forth to aid in an understanding of the subject matter of this disclosure, but are not intended, and should not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

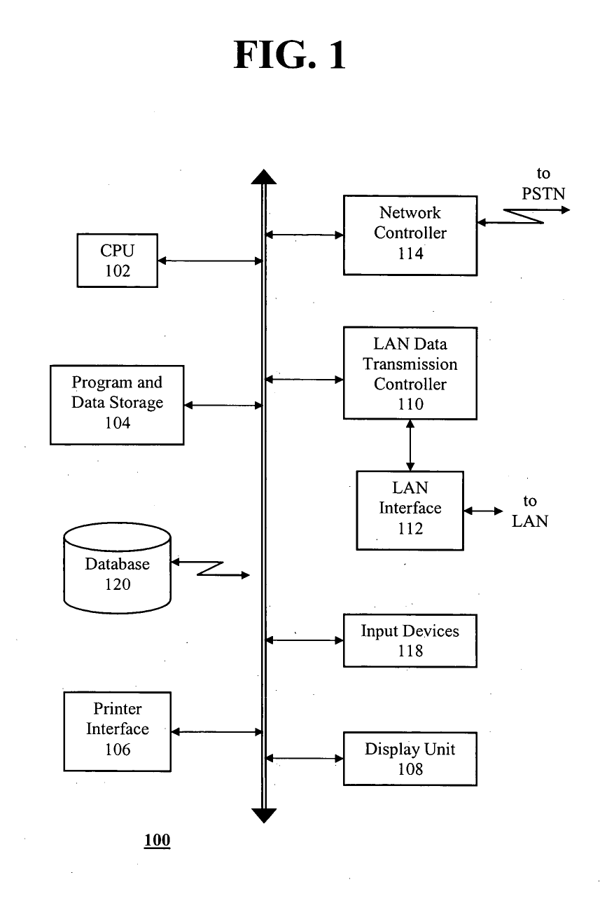

FIG. 1 shows an example of a computer system 100 which can implement the methods and apparatuses of the present disclosure. The apparatuses and methods of the present disclosure may be implemented in the form of a software application running on a computer system, for example, a mainframe, personal computer (PC), handheld computer, server, etc. The software application may be stored on a recording media locally accessible by the computer system, for example, floppy disk, compact disk, hard disk, etc., or may be remote from the computer system and accessible via a hard wired or wireless connection to a computer network, (for example, a local area network, the Internet, etc.) or another transmission medium. Alternatively, the apparatuses and methods of this application, as will be apparent to one skilled in the art after reading this disclosure, can be implemented in hardware or firmware.

The computer system 100 can include a central processing unit (CPU) 102, program and data storage devices 104, a printer interface 106, a display unit 108, a (LAN) local area network data transmission controller 110, a LAN interface 112, a network controller 114, an internal bus 116, and one or more input devices 118 (for example, a keyboard, mouse etc.). As shown, the system 100 may be connected to a database 120, via a link 122.

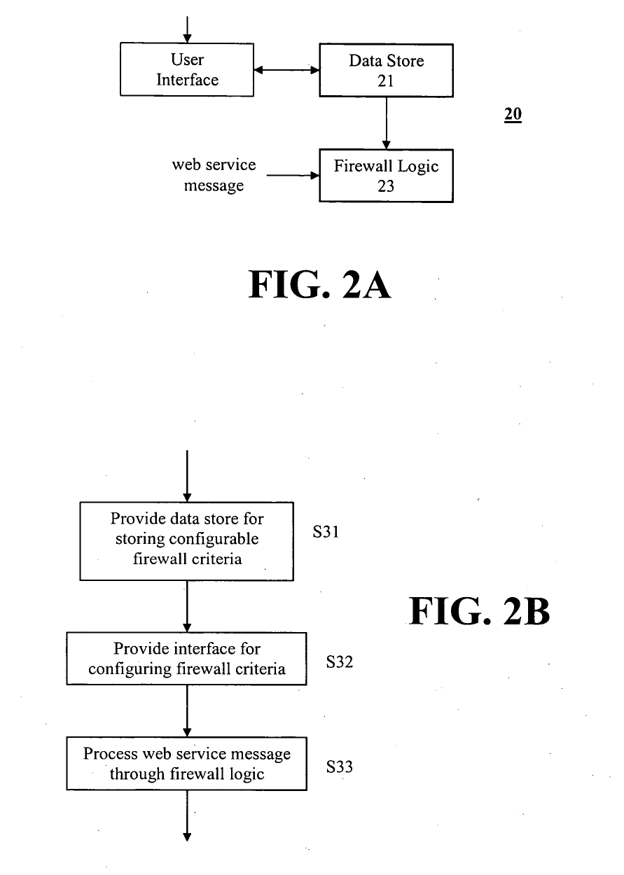

An exemplary embodiment of this disclosure is discussed below with reference to FIGS. 2A and 2B. An apparatus 20 for processing a web service message is shown in FIG. 2A. The apparatus 20 includes a data store 21 and firewall logic means 23. The data store is provided for storing configurable firewall criteria (step S31). An interface is provided for configuring the firewall criteria (step S32). A web service message is processed through the firewall logic means which applies the firewall criteria stored in the data store (step S33).

The configurable firewall criteria can include parameters for one or more of the following:
(a) scanning ports and detecting denial of service attacks;
(b) checking for valid XML;
(c) translating and verifying a destination address of the web service message;
(d) placing the web service message in a canonicalized form;
(e) translating and verifying the data of the web service message;
(f) checking for correctly formatted packets;
(g) checking a signature of the web service message;
(h) identifying a source of the web service message; and
(i) determining whether access to a particular resource is restricted.

Features (a) through (i) are discussed in more detail in this application as well as in commonly owned U.S. Provisional Application No. 60/573,580, filed May 21, 2004 and entitled “METHOD AND APPARATUS FOR PROVIDING SECURITY TO WEB SERVICES”, the entire contents of which are incorporated herein by reference.

An audit log containing results obtained from one or more of (a) through (i) may optionally be created.

The methods and apparatuses of this disclosure can be integrated, according to one exemplary embodiment, in a firewall hardware device to provide added security features, for example, additional protection to computer systems that host web services. The firewall device can intercept a web service message and determine whether the web service message is undesirable. Web service messages identified as undesirable can be immediately blocked, thereby obviating the need for further processing.

The firewall device can optionally be provided with a list of trusted web services or a link to a UDDI server in order to perform address and parameter translation. Translation techniques are discussed in commonly owned U.S. Provisional Application No. 60/573,598, filed May 21, 2004 and entitled “METHOD AND APPARATUS FOR WEB SERVICE COMMUNICATION”, the entire contents of which are incorporated herein by reference.

While some functions may not be ideal for the firewall hardware device (for example, identity authentication and access control may obtain access to large databases that may not be suitable for storage on the firewall hardware device, by using standard web services protocols or traditional security protocols), the firewall hardware device can easily be integrated with existing infrastructure.

While some external server access may be provided, judicious use of caching can greatly speed response time, especially for repeated requests.

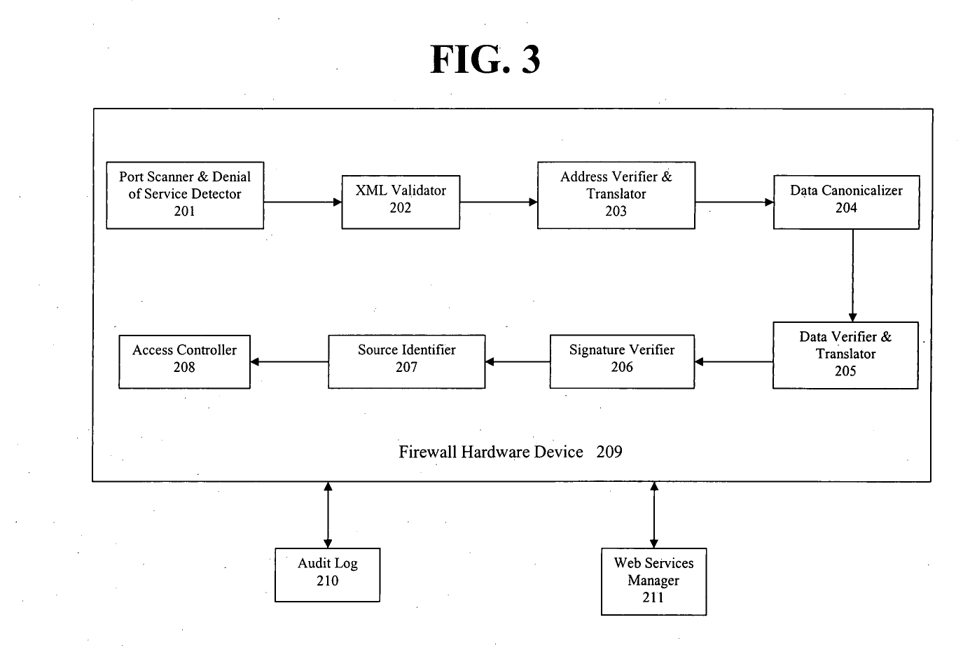

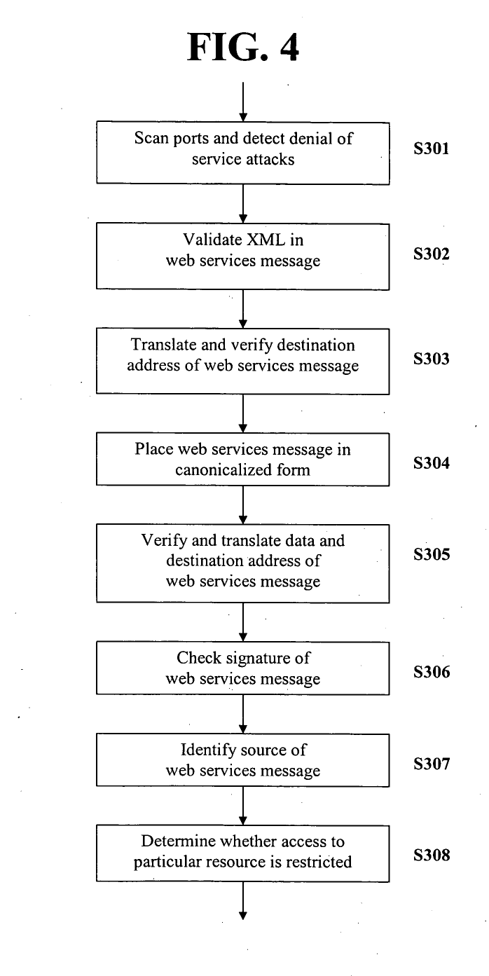

FIG. 3 is a block diagram illustrating an apparatus for processing a web service message, according to an exemplary embodiment. Apparatus 209 can include a port scanner and denial of service (DOS) detector 201, an XML validator 202, an address verifier and translator 203, a data canonicalizer 204, a data verifier and translator 205, a signature verifier 206, a source identifier 207, and/or an access controller 208. An audit log 210 and a web services manager 211 can also be provided. Each of these components is described in further detail in connection with FIG. 4.

FIG. 4 is a flow chart illustrating a method for processing a web service message, according to another exemplary embodiment. For all of the steps, an internal cache can be configured, for example, by using a web based graphical user interface (GUI). The GUI can enable a user to manually configure the verification and translation specifications.

Traditional firewall tasks, such as port scanning and denial of service detection (Step S301), can be performed by the firewall hardware device. The XML in a web service message can be validated (Step S302) by checking to see if the XML data is correctly structured. The destination address of the web service message can be translated and verified (Step S303).

The web service message can be placed in a canonicalized form (Step S304). This step can disrupt a conventional digital signature, but does not interfere with a proper XML digital signature. This step can be a configurable option since the conventional digital signature may remain intact for some applications. According to another exemplary embodiment, the original raw XML can be included as another part of the web service message.

The data and destination address of the web service message can be verified and translated (Step S305). An internal cache can be checked to determine if the web services destination is already known. If it is not known, a quick lookup using for example, an external web services registry service that supports the Universal Description, Discovery and Integration (UDDI) protocol, can determine whether the requested web service exists, immediately rejecting requests for non-existent web services.

Incoming messages can optionally be translated using for example, simple queries against a Universal Description, Discovery and Integration (UDDI) Server (or an internal cache). Using a UDDI query (or equivalent cached data), the firewall can verify that the data meets the specifications of a Web Services Description Language (WSDL) file. The WSDL file can describe all of the information for accessing a web service. Once verified, if desirable, the data fields in the XML can be translated to match those specified by the WSDL file.

The signature of the web service message can be checked (Step S306) by using for example, an XML Key Information Service Specification (XKISS) protocol to check the validity of signing certificates, Online Certificate Status Protocol (OCSP) to determine certificate status, etc. The certificates may optionally be cached for a certain period between XKISS requests, in order to improve efficiency.

The source of the web service message can be identified and authenticated (Step S307) by using, for example, pre-configured usernames and passwords, or by registering trusted cryptographic keys with the device, such as the public key of a trusted certificate authority.

It can be determined whether access to a particular resource is restricted (Step S308) by using pre-configured policy. Some policies may be entered by using a GUI (for example, “all authenticated managers can access this web service”), while other policies may be entered by using a standard policy description protocol, such as an Extensible Access Control Markup Language (XACML) access control policy, WS-Policy, etc.

The firewall hardware device can optionally create an audit log, allowing for future forensic examination of data. The data can be logged to an external port or device, and/or an internal memory storage that can be regularly downloaded and cleared.

The firewall hardware device may publish its status and accept secure commands by using, for example, the Web Services Distributed Management (WSDM) protocol.

The ability to access external servers for message origin identification, authentication, and/or authorization/access control can optionally be provided. The firewall hardware device can use, for example, a Security Assertion Markup Language (SAML) token contained in a web service message and interrogate a server that uses its own policy to evaluate whether the SAML token is to be allowed to authorize the web service message.

The specific embodiments described herein are illustrative, and many additional modifications and variations can be introduced on these embodiments without departing from the spirit of the disclosure or from the scope of the appended claims. For example, elements (such as steps) and/or features of different illustrative embodiments may be combined with each other and/or substituted for each other within the scope of this disclosure and appended claims.

Additional variations may be apparent to one of ordinary skill in the art from reading U.S. provisional application Ser. No. 60/573,552, filed May 21, 2004, the entire contents of which are incorporated herein by reference.

What is claimed is:

1. An apparatus for processing a web service message, comprising:
a data store for storing configurable firewall criteria;
firewall logic means for processing a web service message according to the firewall criteria stored in the data store.

2. The apparatus of claim 1, wherein said configurable firewall criteria include parameters for one or more of the following firewall functionalities:
(a) scanning ports and detecting denial of service attacks;
(b) checking for valid XML in the web service message;
(c) translating and verifying a destination address of the web service message;
(d) placing the web service message in a canonicalized form;
(e) translating and verifying the data of the web service message; and
(f) checking for correctly formatted packets in the web service message.

3. The apparatus of claim 1, wherein said configurable firewall criteria include parameters for one or more of the following firewall functionalities:
(i) checking a signature of the web service message;
(ii) identifying a source of the web service message; and
(iii) determining whether access to a particular resource requested by the web service message is restricted.

4. A firewall hardware device including the apparatus of claim 1.

5. An apparatus for processing a web service message, comprising:
a data repository for storing parameters to be used by a firewall;
means for enabling a user to configure the parameters stored in the data repository;
means for processing the web service message;
means for determining whether data in the web service message is valid;
means for determining whether a source of the web service message is authorized to pass through the firewall; and
means for allowing the web service message to pass through the firewall if it is determined that the web service message is authorized to pass through the firewall.

6. The apparatus of claim 5, further comprising:
scanning means for scanning ports and detecting denial of service attacks;
checking means for checking for correctly formatted SOAP packets and valid XML;
translating means for translating and verifying a destination address of the web service message;
formatting means for placing the web service message in a canonicalized form; and
verification means for translating and verifying the data of the web service message.

7. The apparatus of claim 6, further comprising means for creating an audit log recording information from at least one of said scanning means, checking means, translating means, formatting means and verification means.

8. The apparatus of claim 5, further comprising:
checking means for checking a signature of the web service message;
identifying means for identifying a source of the web service message; and
determining means for determining whether access to a particular resource is restricted.

9. The apparatus of claim 8, further comprising means for creating an audit log recording information from at least one of said checking means, identifying means and determining means.

10. The apparatus of claim 5, further comprising means for providing real time monitoring information.

11. The apparatus of claim 5, further comprising an interface layer enabling the web service message to be further processed.

12. A firewall hardware device including the apparatus of claim 5.

13. A method for processing a web service message, comprising:
providing a data store for storing configurable firewall criteria;
providing an interface for configuring the firewall criteria;
processing a web service message through firewall logic means which applies the firewall criteria stored in the data store.

14. The method of claim 13, wherein said configurable firewall criteria include parameters for one or more of the following steps:
(a) scanning ports and detecting denial of service attacks;
(b) checking for valid XML;
(c) translating and verifying a destination address of the web service message;
(d) placing the web service message in a canonicalized form;
(e) translating and verifying the data of the web service message; and
(f) checking for correctly formatted packets.

15. The method of claim 13, further comprising:
(i) checking a signature of the web service message;
(ii) identifying a source of the web service message; and
(iii) determining whether access to a particular resource is restricted,
wherein said configurable firewall criteria include parameters for at least one of steps (i) through (iii).

16. A computer system comprising:
a processor; and
a program storage device readable by the computer system, tangibly embodying a program of instructions executable by the processor to perform the method claimed in claim 13.

17. A program storage device readable by a machine, tangibly embodying a program of instructions executable by the machine to perform the method claimed in claim 13.

18. A computer data signal transmitted in one or more segments in a transmission medium which embodies instructions executable by a computer to perform the method claimed in claim 13.

19. A method for processing a web service message, comprising:
providing a data repository for storing parameters to be used by a firewall;
providing an interface for configuring the parameters stored in the data repository;
providing means for processing the web service message;
determining whether data in the web service message is valid;
determining whether a source of the web service message is authorized to pass through the firewall; and
allowing the web service message to pass through the firewall if it is determined that the web service message is authorized to pass through the firewall.

20. The method of claim 19, further comprising:
(a) scanning ports and detecting denial of service attacks;
(b) checking for correctly formatted SOAP packets and valid XML;
(c) translating and verifying a destination address of the web service message;
(d) placing the web service message in a canonicalized form; and
(e) translating and verifying the data of the web service message.

21. The method of claim 20, further comprising creating an audit log recording information from at least one of (a) through (e).

22. The method of claim 19, further comprising:
(i) checking a signature of the web service message;
(ii) identifying a source of the web service message; and
(iii) determining whether access to a particular resource is restricted.

23. The method of claim 22, further comprising creating an audit log recording information from at least one of (i) through (iii).

24. The method of claim 19, further comprising providing real time monitoring information.

25. The method of claim 19, further comprising providing an interface layer enabling the web service message to be further processed.

26. The method of claim 19, further comprising verifying the data of the web service message against limits set in a WSDL file.

27. The method of claim 20, wherein the destination address is checked by using a Universal Description, Discovery and Integration server.

28. A computer system comprising:
a processor; and
a program storage device readable by the computer system, tangibly embodying a program of instructions executable by the processor to perform the method claimed in claim 19.

29. A program storage device readable by a machine, tangibly embodying a program of instructions executable by the machine to perform the method claimed in claim 19.

30. A computer data signal transmitted in one or more segments in a transmission medium which embodies instructions executable by a computer to perform the method claimed in claim 19.
